(19) United States
(12) Patent Application Publication
(10) Pub. No.: US 2009/0292764 A1
(43) Pub. Date: Nov. 26, 2009

(54) SYSTEM AND METHOD FOR LINKING THE REAL WORLD WITH THE CYBERWORLD VIA A DISPLAYABLE OBJECT

(75) Inventors: ISAAC KAMEN, KELOWNA (CA); PADDY KAMEN, KELOWNA (CA)

Correspondence Address: AKC PATENTS, 215 GROVE ST., NEWTON, MA, 02466, US

(73) Assignee: CPLATES MARKETING INC, KELOWNA (CA)

(21) Appl. No.: 12/463,479

(22) Filed: May 11, 2009

Related U.S. Application Data
(60) Provisional application No. 61/054,647, filed on May 20, 2008.

(51) Int. Cl. G06F 15/16; G06F 17/30

(52) U.S. Cl. 709/203; 707/9; 707/E17.059

(57) ABSTRACT

A system for linking the real world with the cyberworld includes a displayable object, a website and a user profile database. The displayable object is configured to be displayed by a user and is positioned so that it is viewed by other users. The displayable object comprises a user name identifier for the user and a website identifier. The website is stored in a server and includes a user name inquiry field. The website is connected to a client machine via a network and is accessed by the second user through the client machine's web browser by entering the website identifier. The user profile database includes the user's profile information which is accessed by the second user via the website by entering the user name identifier in the user name inquiry field.

### CROSS-REFERENCE TO RELATED CO-PENDING APPLICATIONS

This application claims the benefit of U.S. provisional application Ser. No. 61/054,647 filed on May 20, 2008 and entitled SYSTEM AND METHOD FOR LINKING THE REAL WORLD WITH THE CYBERWORLD VIA A DISPLAYABLE OBJECT, AND RELATED METHODS which is commonly assigned and the contents of which are expressly incorporated herein by reference.

### FIELD OF THE INVENTION

The present invention relates to the field of social networking, and more particularly to a system and method for linking the real world with the cyberworld via a displayable object.

### BACKGROUND OF THE INVENTION

Social networking (SN) is a cultural phenomenon in the cyberworld that has revolutionized how people communicate and share information. In recent years, SN has gained increasing popularity, particularly among those in their teens and twenties. Today, approximately 55% of teens between the ages of 12 and 17 are members of a SN website (also known as an “SN site”), such as Facebook and MySpace. There are currently more than 200 SN sites operating online.

People use social networking in order to make new friends and to stay in touch and plan social activities with existing friends and family. Each member of a SN site has the ability to post personal content (e.g., a personal profile, blogs, photos, videos, music, and links to other websites of interest) so that his or her friends and family, or even complete strangers, can view that content. In the last decade, SN has flourished as a means of community building and personal expression; in fact, more than two hundred million people around the world are members of at least one SN site.

While SN sites have helped millions of people sustain relationships with friends and family locally, nationally, and even internationally, the current art is limited in that SN users have limited ways to expand their social network. For example, a user, e.g., Bob, can expand his social network if he knows another SN user directly or indirectly through a friend, the workplace, a family member, or the like. However, this approach cannot be applied in situations where there are not enough other SN users among Bob's friends and family to practically expand his social network. Bob can also try to expand his social network by conducting a search to identify other users with matching profile attributes, such as interests and personality type. However, this approach is impersonal and many users prefer not to use it. Furthermore, other users may not be completely honest in setting their profile attributes, which could lead to Bob adding an inappropriate person to his social network. SN sites may also provide functions for users to respond to messages they receive. However, users sometimes receive unwanted messages and are hesitant to reject the sender. For example, the receiver may not want to appear rude or potentially hurt the sender's feelings. Accordingly, there is a need for an improved SN system that addresses the above mentioned networking situations.

### SUMMARY OF THE INVENTION

In general, in one aspect, the invention features a system for linking the real world with the cyberworld including a displayable object, a website and a user profile database. The displayable object is configured to be worn or carried by a first user and is positioned so that it is viewed by a second user. The displayable object comprises a user name identifier for the first user and a website identifier. The website is stored in a server and includes a user name inquiry field. The website is connected to a client machine via a network and is accessed by the second user through the client machine's web browser by entering the website identifier. The user profile database includes the first user's profile information which is accessed by the second user via the website by entering the user name identifier in the user name inquiry field.

Implementations of this aspect of the invention may include one or more of the following features. The displayable object may be a tag, plate, ring, patch, pin, label, necklace, bracelet, key fob, belt clip, imprint on a piece of clothing, shoe, bag, personal communication device or electronic device, or tattoo. The displayable object may further comprise residence address information of the first user, hologram, logo, symbol, magnetic stripe or bar code. The displayable object may be made of metal, plastic, polycarbonate, flexible material, weather resistant material, or scratch resistant material. The system may further include means for sending messages to the first user by the second user via the website. The system may further include means for the first user to reply to the messages of the second user and means for the first user to evade the messages of the second user. The system may further include means for performing transactions by the first user via the website. The transactions may be making payments, placing orders, purchasing tickets or other digital goods or making reservations. The first user's profile information may include name, address, date of birth, phone number, e-mail address, homepage URL, personal preferences, hobbies, pictures, songs, favorite websites, slogans, videos, or blogs about opinions on politics, films or books. The website may be a social networking website, a merchandising website, a news media website, or a personal website. The system may further include means for registering a user in the website, means for obtaining a displayable object, means for personalizing the displayable object, means for generating a profile, means for entering personalized information in the profile, and means for searching user profiles in the database.

In general, in another aspect, the invention features a method for linking the real world with the cyberworld including the following steps. First, providing a displayable object to a first user and wearing or carrying the displayable object by the first user, so that is visible to a second user. The displayable object includes a user name identifier for the first user and a website identifier. Next, providing a website stored in a server and comprising a user name inquiry field. The server is connected to a client machine via a network. Next, providing a user profile database comprising the first user's profile information. The server is connected to the user profile database and comprises means for retrieving the first user's profile information from the database. Next, accessing the website by the second user through the client machine's web browser by entering the website identifier and retrieving the first user's profile information by the second user from the database via the website by entering the user name identifier in the user name inquiry field.

Implementations of this aspect of the invention may include one or more of the following features. The method may further include sending messages to the first user by the second user via the website. The method may further include replying to the messages of said second user by the first user or evading the messages of the second user by the first user. The method may further include performing transactions by the first user via the website. The transactions may be making payments, placing orders, purchasing tickets or other digital goods or making reservations. The method may further include registering a user in the website, obtaining a displayable object, personalizing the displayable object, generating a profile, entering personalized information in the profile and searching user profiles in the database.

Among the advantages of this invention may be one or more of the following. The invention provides SN users and non users with opportunities to expand their social network by contacting other SN users whom they observe in the real world without having to communicate with them directly. The invention also provides SN users and non users with an opportunity to learn about other SN users they observe in the real world before initiating direct contact with them. The invention also provides SN users with a way to let other users and non users who observe them in the real world learn about them before initiating direct contact.

The invention also provides SN users with an outlet for personal expression. Users control the content of their home pages and can upload pictures, post their favorite songs, and blog about their opinions on politics, films, books, and the like. Personal expression is an important feature of an individual's online life. However, in the real world, there is a limited number of ways in which people can express their individuality using physical products that are displayed on the body, e.g., by wearing a tee shirt or a pin that bears a slogan or the like. One drawback of current physical products for personal expression is that they are not usually designed by the individual, but rather are commercially mass-produced, and therefore the content of the expression is designed to maximize profit rather than express individuality. In other words, very few people have an opportunity to personally design and create a physical product, and therefore typically choose one that is pre-made and not unique to them or their interests. The present invention addresses the need to enhance the ability of people to distinguish themselves from the crowd and personally express themselves to others in the real world, which is especially important to people these days as demonstrated by the increasing popularity of modes of individual expression in the cyberworld, e.g., blogging and video posting.

Additionally, the invention provides opportunities for users to publicize and promote their home page both online in the cyberworld and in the real world and extend their recognition in the cyberworld to the real world. For example, a SN user may have substantial recognition in the cyberworld for their accomplishments, good content, or the like, but be comparatively unrecognized in the real world. The invention also provides SN users a method for rejecting a message without appearing rude or potentially hurting the sender's feelings.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

Referring to the figures, wherein like numerals represent like parts throughout the several views:

FIG. 1A is a front view of a user wearing a displayable tag;

FIG. 1B is a schematic overview diagram of a system that links the real world with the cyberworld via the displayable tag of FIG. 1A;

FIG. 2 is a schematic block diagram of a real world site, which is a physical location in the real world, e.g., a concert, a mall, or a college campus;

FIG. 3 is a flow diagram of a method 300 of enabling a prospective user to create an account, acquire a displayable tag, and display it in the real world;

FIG. 4 shows one example of a database structure used to store a user's “user ID” and the user's profile information;

FIG. 5 shows a screenshot of an exemplary user home page;

FIG. 6 is a flow diagram of a method 600 of acquiring a user ID;

FIG. 7 is a flow diagram of a method 700 of enabling a user to send a message in the cyberworld to an unknown user wearing a displayable tag and being observed in the real world;

FIG. 8 is a flow diagram of a method 800 of selectively responding to or evading a message;

FIG. 9A is a rear perspective view of an exemplary holder for the displayable tag;

FIG. 9B is a top perspective view the exemplary holder of FIG. 9A;

FIG. 9C is a front perspective view of the holder of FIG. 9A with the displayable tag; and

FIG. 10 shows a user wearing the holder and displayable tag on his shoe.

### DETAILED DESCRIPTION OF THE INVENTION

The invention describes a system that utilizes a physical displayable object, such as an identification plate, tag, ring, patch, pin, etc., that a member of an online organization, such as a social networking (SN) website, can wear or otherwise carry and display. This displayable object contains information that allows others in the “real world,” i.e., the physical world in which we live and interact with other people, to make contact with the member via the online organization without necessarily having to first interact with the member in the real world.

For example, consider a case where two SN website users, Alice and Bob, are in the same location in the real world, e.g., at a concert, a mall, or a college campus. Alice does not know Bob, but she observes him and would like to learn about, contact, and perhaps befriend him. Such an event provides an opportunity for Alice to expand her social network. However, prior to the present invention, Alice could not do so without directly approaching Bob, which she may not be inclined to do because of shyness or time constraints, resulting in a lost opportunity for both Alice and Bob to expand their social networks. In short, conventional SN sites do not provide their users with the ability to contact an anonymous person that he or she has observed in the real world.

In one implementation, these needs are addressed by a displayable object that Bob can wear or otherwise carry that displays information Alice can observe and use to contact Bob through the SN site corresponding to the information on the displayable object. As will be described further below, the displayed information is unique to Bob (at least relative to the particular SN site at issue). An example of such displayed information is a uniform resource locator (URL) of a webpage of the SN site and a unique alphanumeric sequence that Bob has chosen or the SN site has assigned.

Moreover, SN sites currently provide no way for a user to expand his or her network so as to include nonusers in the real world. For example, in a variation of the case described above wherein Alice and Bob are in the same location in the real world, Alice may not be a user of the SN site of which Bob is a member. In this case, there is a significant lost opportunity for Alice and Bob to expand their social networks. The present inventors have also recognized a need to provide SN users with opportunities to expand their social networks to include nonusers who observe them in the real world. For example, in a variation of the case described above wherein Alice and Bob are in the same location in the real world, Alice may not know anything about the SN site of which Bob is a member. Without the displayable object, as displayed by Bob, there is a significant lost opportunity for Alice and Bob to expand their social networks. This need is also addressed by a displayable object and related methods of the present disclosure.

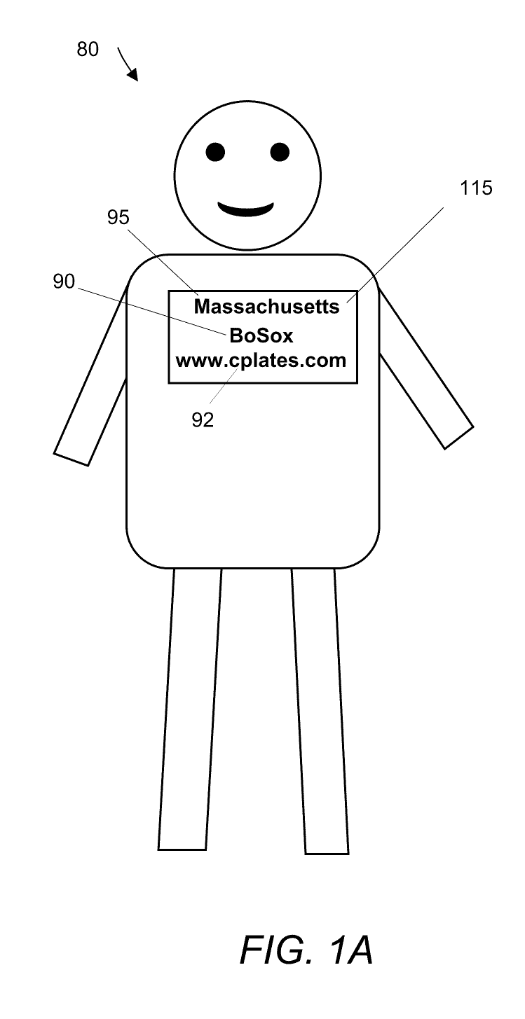

Referring to FIG. 1B, a system 100 that links the real world with the cyberworld via a displayable object 115 includes client machines 110, 120 connecting to a server 141 via a network 130 and accessing a SN website 140 stored in the server 141. The displayable object 115 is a tag that is worn by a user 80 who is registered with the SN website and has a user identification and a profile stored in database 142. The client machines 110, 120 are conventional computing devices, such as personal computers, personal digital assistants, and web-enabled cell phones, and comprise conventional Web browsers 111, 121, e.g., Internet Explorer.

The website 140 is typically a social networking site, but may also be a merchandising site, a news media site, or the like, that incorporates social networking functions. Examples of websites 140 include Cplates, Facebook, MySpace, Amazon which are accessed via their corresponding Uniform Resource Locator (URL) identifier, www. Cplates, www.facebook.com, www.myspace.com, www.amazon.com, respectively, among others. Users 80, 82 enter the URL identifier into the Web browsers 111, 121, respectively, to navigate to the website 140. System 100 also includes a database 142 storing the user's profiles, a mail server 143 for sending messages between the client machines and the server, and a transaction server 144.

The Web server 141 is a computer that runs a web service application, e.g., Apache HTTP Server, that accepts HTTP requests from the Web browsers 111, 121 on the client machines 110, 120, and serves HTTP responses back to the client machines 110, 120 along with optional content, e.g., web pages such as HTML documents and linked objects. The database 142 is a computer that provides database services via a database management system such as MySQL. The mail server 143 is a computer that runs a messaging system, such as sendmail, in order to provide messaging store and forward capabilities. The transaction server 144 is a computer that hosts a transaction processing service in order to process payments and place orders reliably. It should be appreciated that each of the servers 141-144 may comprise a single computer or multiple computers; furthermore, any combination of two or more of the servers 141-144 may constitute a single computer.

According to one implementation, the network 130 comprises the Internet. However, it should be appreciated that the network 130 may comprise a LAN, WAN, or other type of network suitable for connecting the client machines 110, 120 and the Web server 141. In addition, as shown in FIG. 1B, the client machines 110, 120 and the Web server 141 are communicatively coupled to one another through respective connections to the network 130. In addition, the Web server 141 is communicatively coupled to the database 142, the mail server 143, and the transaction server 144.

A registered user Bob 80 has a displayable object 115 and can access the system 100 using the web browser 111 on the client machine 110. In addition, a passerby, Alice 82, who is not a registered user and does not have a displayable object, can access the system 100 using the Web browser 121 on the client machine 120. FIG. 1A shows an exemplary embodiment of the displayable object 115, which in this case is a wearable tag that includes the user id 90, the SN website 92 and the state where the user resides 95.

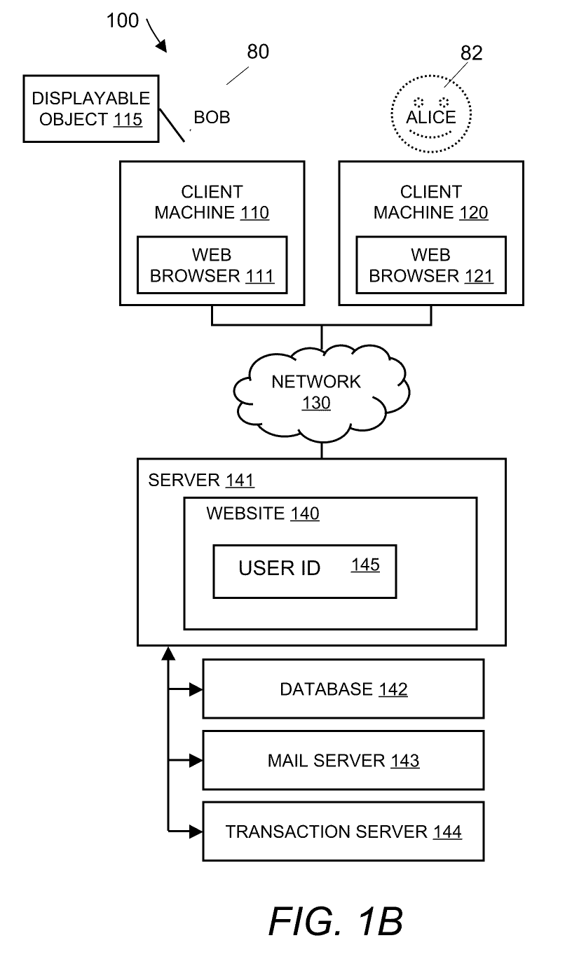

FIG. 2 is a diagram of a real world site 200, which is a physical location in the real world, e.g., a concert, a mall, or a college campus. In the real world site 200, a passerby Alice is in physical proximity to a plurality of registered users of the system 100, including Bob, Carol, and Dave who have displayable objects 115, 116, 117, respectively. In the present figure, only three registered users are shown, but the present invention is not limited thereto and typically there would be numerous users of the system in the real world. Furthermore, Alice is capable of observing the displayable object 115 (and potentially the displayable object 116, 117) and reading information that is formed thereon.

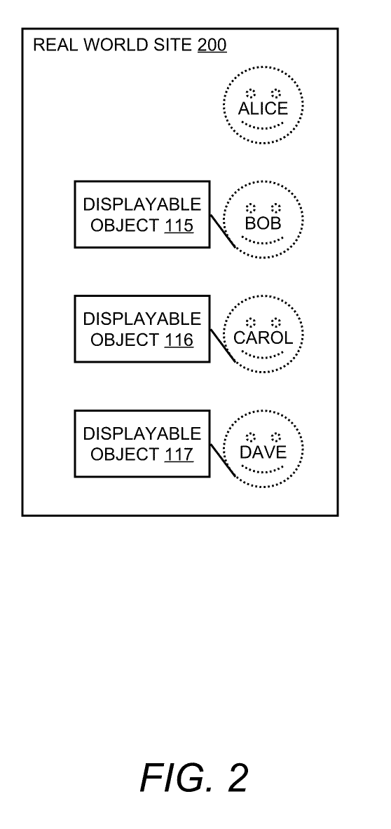

FIG. 3 depicts a flow diagram for a method 300 of enabling a prospective user to create an account, acquire a displayable object, and display it in the real world. To facilitate the explanation, the prospective user in this method is assumed to be Bob before he became a registered user and obtained his displayable object 115. Furthermore, it is assumed that Bob interacts with the system 100 by using the Web browser 111 on the client machine 110.

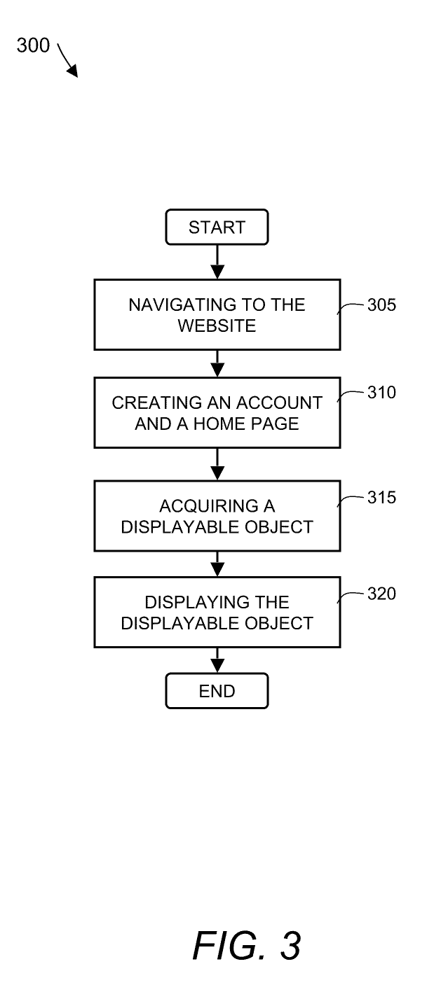

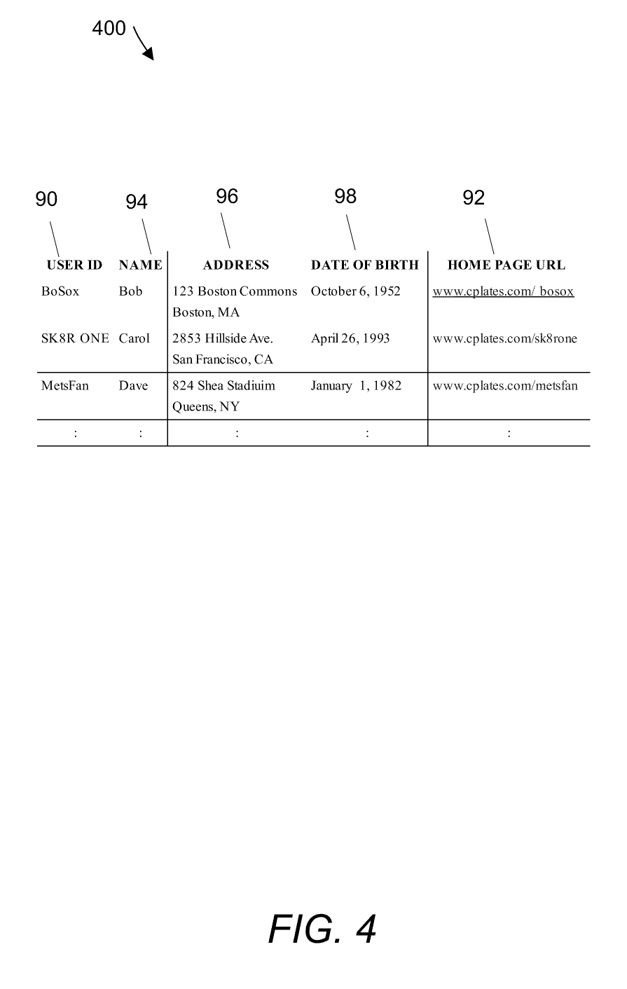

Referring to FIG. 3, in step 305, Bob inputs the website URL in the Web browser 111 on the client machine 110 in order to navigate to the website 140 via the network 130. In step 310, Bob acquires a user ID in accordance with method 600, which is described in detail below. Next, the Web server 141 presents a prompt to Bob to provide personal account information, e.g., name, address, and date of birth. Bob provides the necessary account information, and the Web server 141 requests the database 142 to store Bob's account information so that it is associated with his user ID. FIG. 4 shows a database structure 400 that can be used to store Bob's account information, as well as other information, so that it is associated with his user ID. The database structure 400 will be discussed in detail later. Furthermore, Bob interacts with the Web server 141, which interacts with the other servers as needed, in order to create a home page in accordance with the conventional art, after which the Web server 141 stores Bob's home page and requests the database 142 to store the URL of Bob's home page so that it is associated with his user ID. FIG. 5 shows a screenshot of an exemplary home page, which will be discussed in detail later. In step 315, the Web server 141 presents Bob with an order form for ordering the displayable object 115. Bob uses the order form to specify an order in a manner according to the conventional art, e.g., providing a shipping address and a method of payment such as a credit card number. The Web server 141 provides Bob's order information to the transaction server 144 with a request to place an order for the displayable object 115 with Bob's user ID and the website URL formed thereon. The transaction server 144 processes the payment, places an order with a manufacturer to manufacture Bob's displayable object 115. The displayable object 115 is subsequently manufactured and shipped to Bob. In step 320, Bob receives the shipped displayable object 115 and displays it on his person, or a personal item that he wears, carries, or otherwise transports (such as a backpack, briefcase, etc.) so that it is visible to others. The method subsequently ends.

In the method 300, Bob both creates an account, creates a home page, and acquires and displays the displayable object 115, whereon the user ID and the website URL are formed. In an alternative embodiment, Bob may create an account and create a home page, but skip the remainder of the method, i.e., he may skip acquiring and displaying the displayable object 115. This is advantageous in the case wherein Bob wants the capability to send messages to other users but personally does not want a displayable object because, for example, he wishes to maintain anonymity in the real world or he does not presently wish to purchase a displayable object.

FIG. 4 shows one example of a database structure 400 that can be used to store user IDs and information therewith, e.g., account information and home page URLs. It can be seen in FIG. 4 that the database structure 400 is a flat file comprising five columns that represent the user ID 90, name 94, address 96, date of birth 98, and home page URL 92. However, the present invention is not limited to this structure and may be a differently ordered flat file, a hierarchical database, a network database, an object database, or a relational database, provided that the structure can store user information, e.g., account information and home page URLs, associated with the corresponding user IDs.

FIG. 5 shows an exemplary screenshot of a home page 500, which is associated with the user, Carol. As can be seen in the figure, the home page 500 includes a photo 501 and a profile 505 of Carol, whose user ID 90 is “SK8R ONE,” as well as an image 510 of her displayable object 116. Furthermore, the home page 500 includes a button 502 for searching for a user and a button 503 for messaging a user. Additionally, the home page 500 includes links 504 to Carol's favorite sites, which may be sites where she also posts personal content. Thus, the home page 500 is linked to Carol's displayable object 116, which she displays in the real world; therefore, the home page 500 is advantageous in that it enables Carol to promote and publicize her cyberworld content in the real world via the displayable object 116. The home page 500 is also advantageous in that it functions as a portal for various web services and includes links 504 to other websites, such as other SN sites (e.g. www.facebook.com), blogging sites, photo sites (e.g., www.flickr.com), and video posting sites (e.g., www.youtube.com).

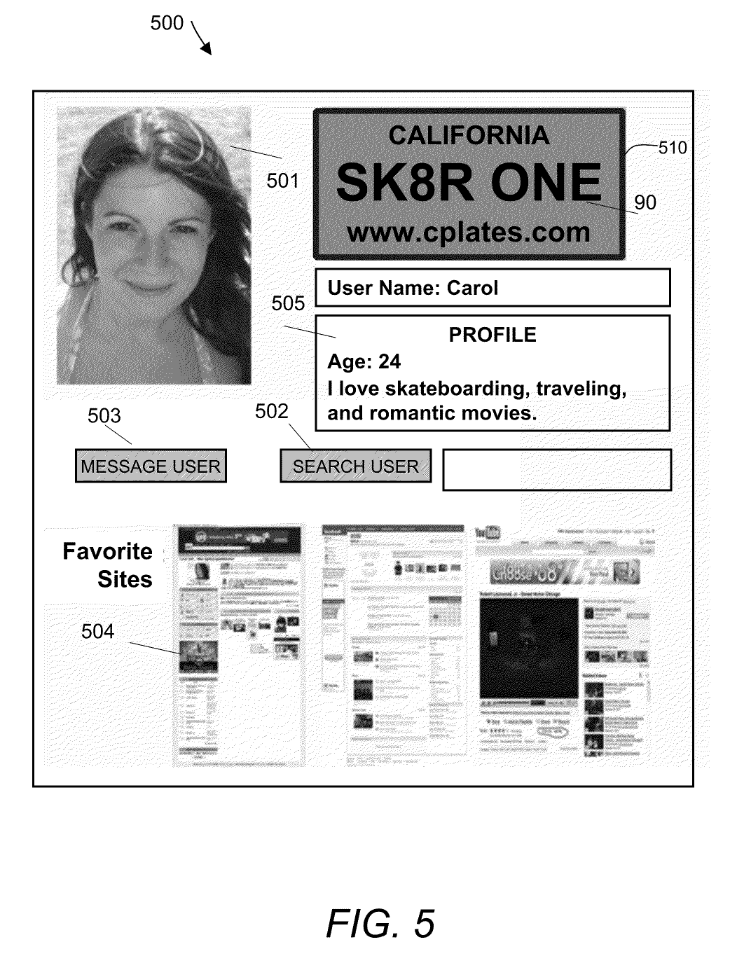

FIG. 6 is a flow diagram that depicts a method 600 of acquiring a user ID. First, in step 605, the Web server 141 presents an inquiry to a user, e.g., Bob, asking whether he wishes to create a customized user ID or to have a generic ID automatically assigned to him. The method transitions to step 610 if Bob indicates that he wishes to create a customized ID, or to step 625 if Bob indicates that he wishes to have an ID automatically assigned to him. In step 610, the Web server 141 presents Bob with a form for him to specify his unique user ID so that it is different from the user IDs of other users. Specifically, the form contains one or more variables that enable Bob to differentiate his user ID. Herein, these variables are referred to as differentiating variables. Typically, two differentiating variables are specified: a plateline, which is composed of alphanumeric characters (e.g., BoSox), and a territory (e.g., Massachusetts); however the present invention is not limited thereto and may utilize more than two differentiating variables. Other examples of differentiating variables that might be offered for Bob to specify his user ID include color, shape (e.g., square, rectangle, oval, or circle), symbol (e.g., heart, lightening bolt, moon, or diamond), and frame (e.g., a black square with a white frame, or a purple triangle with a black frame). Bob selects values for the differentiating variables, e.g., the plateline “BoSox” and the territory “Massachusetts,” to form a combination that constitutes his user ID. In step 615, the Web server 141 queries the database 142 to check whether the user ID created by Bob is already registered, i.e., whether it is already assigned to another user. The method transitions to step 620 if it is already registered, and otherwise transitions to step 630. In step 620, the Web server 141 presents a message to Bob to the effect that his created user ID is already registered and asks whether he wants to try again. The method returns to step 610 if Bob chooses to try again, and otherwise the method ends. In step 625, the Web server 141 automatically generates a unique ID that is not already registered in the database 142, and assigns such to Bob. The Web server 141 may use any of various conventional methods of generating a unique ID, including but not limited to: randomly generating values (e.g., jyS8e3L); combining two or more values from a dictionary of values (e.g., PinTruck); and the like. The method then transitions to step 630. In step 630, the Web server 141 issues a request to the database 142 to store Bob's user ID. The method subsequently ends.

In an alternative embodiment, certain user IDs that are thought to be popular and desirable, e.g., “BEATLES,” may be reserved and offered for sale at a premium price or auctioned off. Furthermore, Bob may acquire multiple user IDs and displayable objects so that he can selectively display different displayable objects depending on his mood or the occasion.

The use of the displayable object 115 in combination with the system 100 is advantageous in that it allows a user, e.g., Bob, to easily represent, in the real world, his online personality and to encourage other people to discover more about what makes him unique and interesting. Moreover, it affords the opportunity for Bob to more effectively promote himself and obtain greater recognition in the real world for his online activities e.g., sites, blogs, video postings.

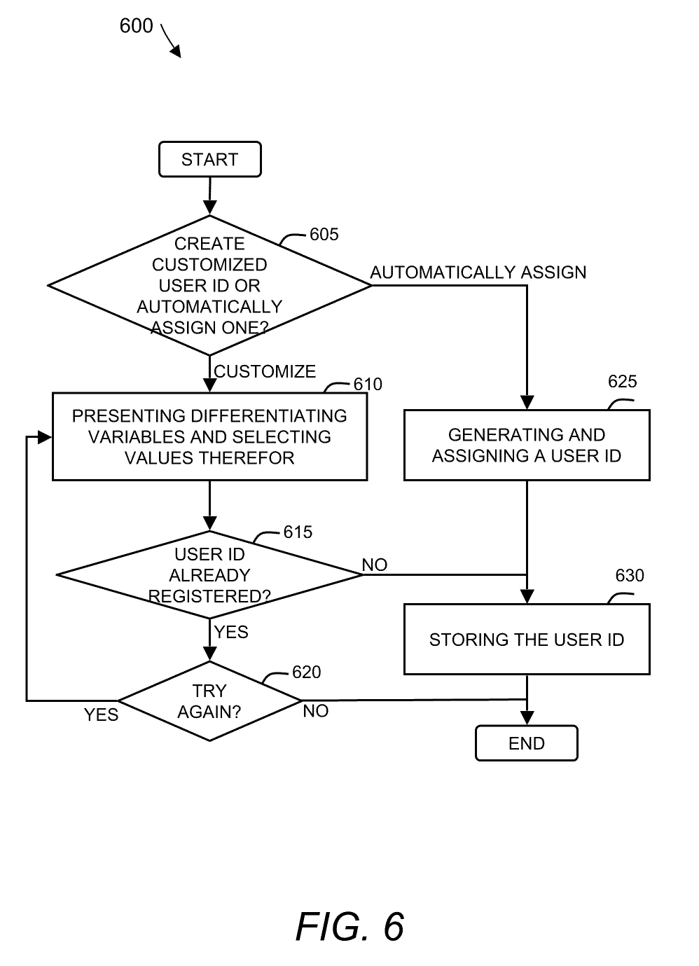

FIG. 7 is a flow diagram that depicts a method 700 of enabling a passerby to send a message in the cyberworld to an unknown user observed in the real world. In step 705, a passerby, e.g., Alice, sees a user, e.g., Bob, somewhere in the real world, e.g., the real world site 200 shown in FIG. 2. Furthermore, Alice observes the displayable object 115, which is displayed by Bob, and notes the user ID and the website URL that are formed thereon. In the present method, it is assumed that Alice does not know Bob's real world identity, e.g., his name, address, etc. Furthermore, Alice is depicted in FIG. 2 without a displayable object; however, in the present method, she may or may not be a user, i.e., she may or may not have an account and a home page at the web site 140. Next, in step 710, Alice inputs the observed website URL into the Web browser 121 on the client machine 120 in order to navigate to the website 140. Alice inputs Bob's user ID into a user search field, which may be presented, for example, on the home page of the website 140 or by clicking on a user search link thereon. The Web server 141 queries the database 142 to determine whether the ID that was inputted by Alice exists in the database 142. In step 715, the method transitions to step 720 if Bob's user ID is found, and otherwise transitions to step 730. In step 720, the Web server 141 presents Bob's profile to Alice based on the data stored in the database 142 that is associated with Bob's user ID, which was found in the search. Typically, the profile that is presented in this step is abbreviated, e.g., it includes just Bob's ID and photo, but the present invention is not limited thereto. Herein, the extent of the abbreviation of the displayed profile can be decided by each user of the system 100 in a conventional manner, such as by adjusting privacy settings. In step 725, the Web server 141 presents an inquiry to Alice asking whether she would like to send a message to Bob (or to the user of the similar user ID selected in step 770). The method transitions to step 740 if Alice indicates that she wishes to send a message to Bob, and otherwise the method ends. In step 730, the Web server 141 queries the database 142 for user IDs of other users that are similar to the user ID that was entered by Alice, and presents the search results to Alice. In step 735, the method transitions to step 720 if Alice selects a user ID that was found in step 730, and otherwise the method ends. In step 740, the Web server 141 presents a message to Alice informing her that she must log in to the website 140 in order to send a message to Bob. In step 745, the method transitions to step 750 if Alice has an account and logs in, and otherwise transitions to step 760. In step 750, Alice enters her login information into the login field. Next, in step 755, the Web server 141 presents a conventional message form to Alice. Next, Alice enters her message to Bob in the message form and, for example, selects a send button in order to request delivery of the message to Bob. The Web server 141 then requests the mail server 143 to route the message from Alice to Bob (and optionally to send a copy of the message to Alice). The message optionally includes an abbreviated profile of Alice. The method subsequently ends. In step 760, the Web server 141 presents a refusal message to Alice to the effect that she cannot contact Bob without an account, and presents an inquiry asking whether she wishes to create an account. The method transitions to step 765 if Alice chooses to create an account, and otherwise the method ends. In step 765, Alice creates an account and home page in accordance with step 310 of the method 300, and optionally acquires and displays a displayable object in accordance with steps 315-320 of the same method. The method then returns to step 750.

In the present method, it is assumed that Alice does not know the real world identity of Bob (e.g. his name), but the present invention is not limited thereto, i.e., the method is applicable even if Alice does know Bob's real world identity. In such a case, the method is still advantageous if, for example, Alice were busy and did not have time to speak with Bob. Alice would note the user ID and website URL formed on Bob's displayable object 115 and send a message to him at a time more convenient for her.

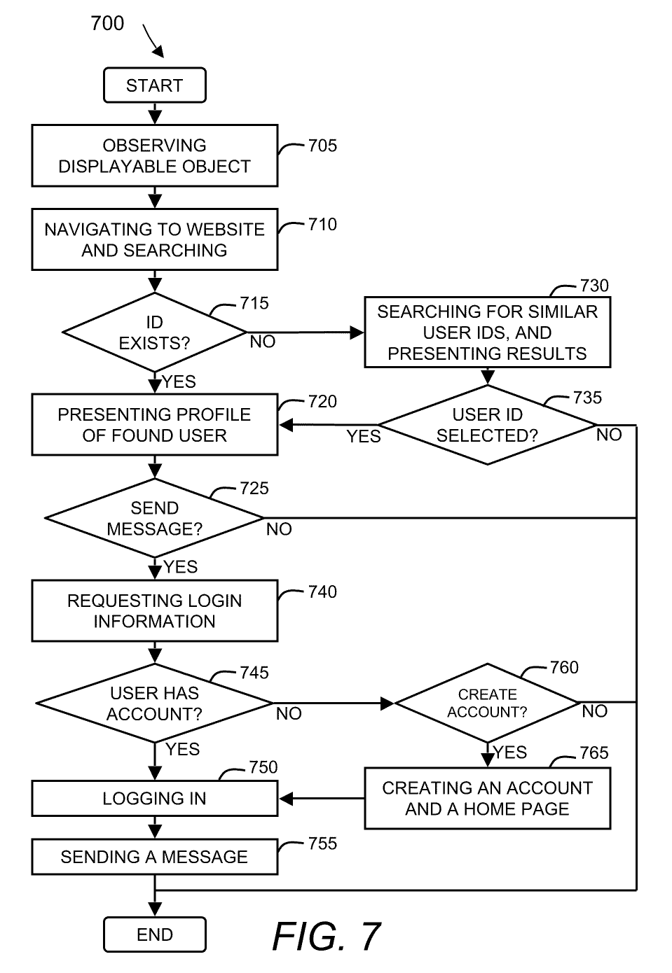

FIG. 8 is a flow diagram that depicts a method 800 of selectively responding to or evading a message. First, in step 805, Bob receives the message from Alice. The received message optionally includes an abbreviated profile of Alice that Bob can view without having to open and/or read the message. Bob opens and reads the message. In step 810, Bob decides whether to respond to the received message, e.g., by composing his own reply message, or to evade the received message, e.g., by selecting an evasive reply message. Bob bases his decision on whether, for example, he desires to communicate with Alice, he has sufficient time, and the like. The method transitions to step 815 if Bob chooses to respond to the received message, and to step 820 if he chooses to evade the received message. In step 815, Bob responds to Alice personally in a conventional manner, e.g., by clicking on a reply button, typing in a reply message, and then clicking a send button. The method subsequently ends. In step 820, the Web server 141 presents Bob with the option to select one or more boilerplate evasive messages. One example of a boilerplate evasive message is “Your message was unable to be delivered because the user's privacy settings are set too high.” Such a boilerplate evasive message is advantageous in that it enables Bob to reject Alice's attempt to communicate with him without, for example, appearing rude or potentially hurting Alice's feelings because the evasive message makes it appear as though Bob never received her message. The evasive message is also advantageous in that it may discourage Alice from endeavoring to send additional messages to Bob in the future, which could be annoying to Bob and constitute harassment. Bob selects a boilerplate evasive message and the Web server 141 requests the mail server 143 to route a message that contains the selected boilerplate evasive message. Subsequently, the method ends.

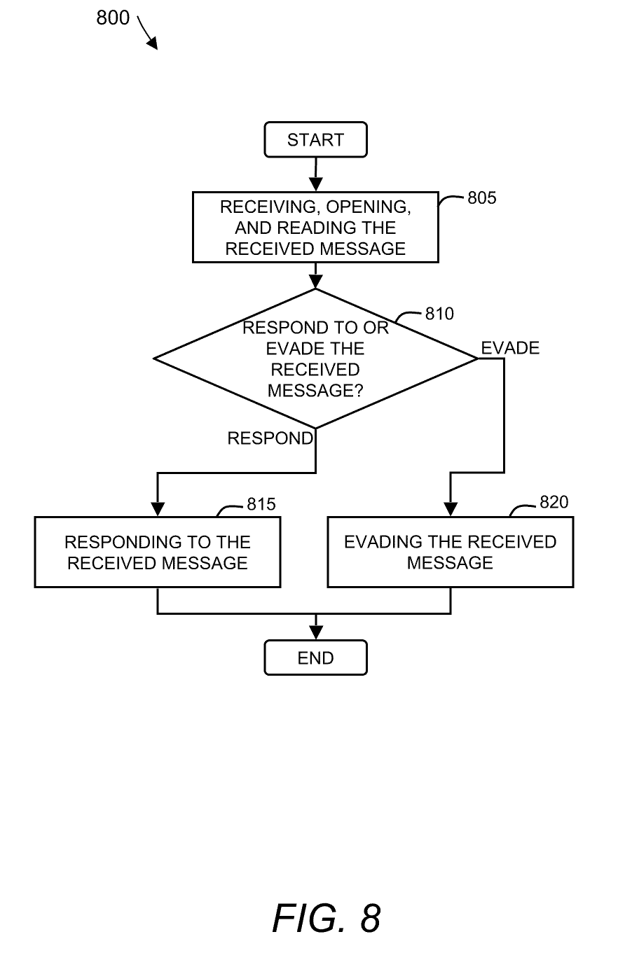

FIG. 9C is a front view of an exemplary displayable object 115 held by a frame 150. In this example, the displayable object 115 is formed from material that is durable, weather resistant, and flexible, e.g., it can bend around the back of a shoe or a baseball hat but then return to a substantially flat configuration for attaching to the back pocket of a pair of jeans. Examples of materials that can be used to form the displayable object 115 include metals and plastics, such as polycarbonate. Polycarbonate is advantageous because of its lower cost. The dimensions of the displayable object 115 in the figure are approximately 3.25 (W)×1.6 (H)×0.024 (D) inches.

As shown in FIG. 9C and FIG. 1A, the user ID 90 of the user 80 and the website URL 92 are formed on the wearable object 115. The displayable object 115 may also have a hologram formed thereon with a logo of, for example, the website 140. Furthermore, the displayable object 115 may have a magnetic stripe, a bar code, or the like formed on its rear surface that contains, for example, authentication information and personal information. The stripe or the like can be read by a reader that is incorporated into, for example, an identification reader or a payment terminal that is installed at a venue such as a college campus event. In other embodiments, the displayable object 115 may be a larger object, such as a protest sign, or a smaller object, such as ring, provided that the user ID and website URL can be observed by others in the real world.

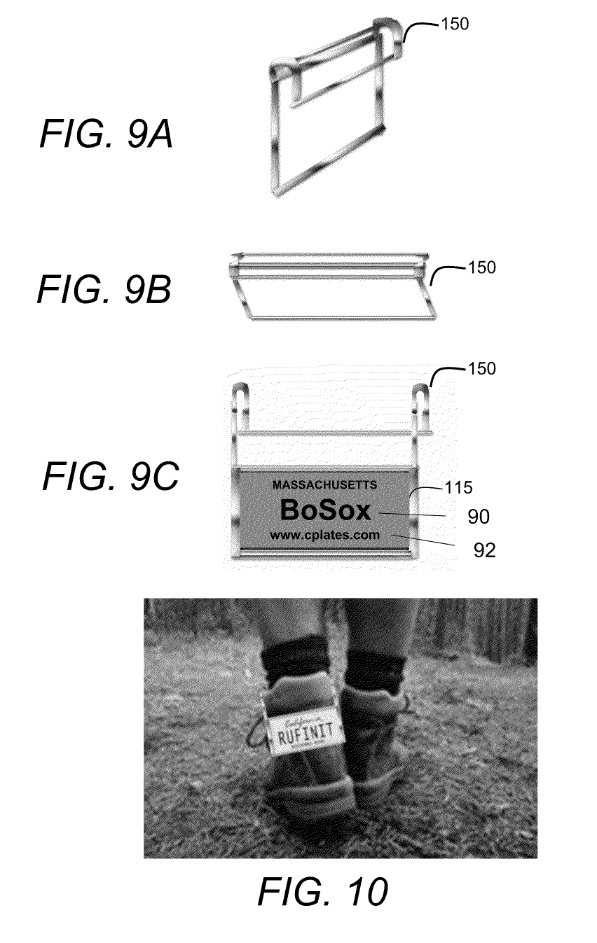

FIG. 9A shows a rear perspective view of an exemplary holder 150 that holds the displayable object. FIG. 9B is a top perspective view of holder 150 and FIG. 9C is a front perspective view of the holder 150 with the displayable object 115 disposed therein. FIG. 10 is a photograph that shows a user wearing the holder and displayable object on his shoe. Bob can easily insert and remove the displayable object 115 into and from the holder 150, which has the advantage of providing Bob with an option to select one displayable object from a plurality of displayable objects depending on his mood or the occasion. In other embodiments, the displayable object 115 may be held by some other fastening means, e.g., a necklace, a pin, or a clip.

In an alternative embodiment, the displayable object 115 may be affixed to Bob by a means other than a holder, e.g., the displayable object 115 may be affixed by an adhesive, Velcro, or the like. Furthermore, the displayable object may, for example, be inserted into a pocket on an article of clothing, e.g., a shirt pocket, wherein the exterior material of the pocket is made of a transparent material so that the displayable object 115 can be viewed when it is disposed therein. Furthermore, the displayable object 115 may be stored in a location where it is not displayed, e.g., in a user's wallet, and then taken out and selectively displayed when desired.

The displayable object 115 may also comprise some other worn accessory, such as a tie clip, pin, necklace, bracelet, key fob, or belt clip; in addition, it may be affixed to an article of clothing, such as a shoe, pants, or shirt; furthermore, it may be attached to a carried object, such as a purse, hip pouch, backpack, or shoulder bag. In an alternative embodiment, the user ID and website URL may be displayed in the real world without a displayable object, e.g., tattooed on the body; embroidered, printed, or otherwise formed on an article of clothing; printed or otherwise formed on devices such as an MP3 player, PDA, or cell phone; or printed or otherwise formed on a carried object as mentioned above.

Several embodiments of the present invention have been described. Nevertheless, it will be understood that various modifications may be made without departing from the spirit and scope of the invention. Accordingly, other embodiments are within the scope of the following claims.

What is claimed is:

1. A system for linking the real world with the cyberworld comprising:
a displayable object configured to be worn or carried by a first user and positioned to be visible by a second user, wherein said displayable object comprises a user name identifier for said first user and a website identifier;
a website stored in a server and comprising a user name inquiry field, wherein said website is connected to a client machine via a network and is accessed by said second user through said client machine's web browser by entering said website identifier; and
a user profile database comprising said first user's profile information and wherein said first user's profile information is accessed by said second user via said website by entering said user name identifier in said user name inquiry field.

2. The system of claim 1 wherein said displayable object comprises one of tag, plate, ring, patch, pin, label, necklace, bracelet, key fob, belt clip, imprint on a piece of clothing, shoe, bag, personal communication device or electronic device, or tattoo.

3. The system of claim 1 wherein said displayable object further comprises one of residence address information of said first user, hologram, logo, symbol, magnetic stripe or bar code.

4. The system of claim 1 wherein said displayable object comprises one of metal, plastic, polycarbonate, flexible material, weather resistant material, or scratch resistant material.

5. The system of claim 1 further comprising means for sending messages to said first user by said second user via said website.

6. The system of claim 5 further comprising means for said first user to reply to said messages of said second user and means for said first user to evade said messages of said second user.

7. The system of claim 1 further comprising means for performing transactions by said first user via said website, wherein said transactions comprise one of making payments, placing orders, purchasing tickets or other digital goods or making reservations.

8. The system of claim 1 wherein said first user's profile information comprise one of name, address, date of birth, phone number, e-mail address, homepage URL, personal preferences, hobbies, pictures, songs, favorite websites, slogans, videos, or blogs about opinions on politics, films or books.

9. The system of claim 1 wherein said website comprises one of a social networking website, a merchandising website, a news media website, or a personal website.

10. The system of claim 1 further comprising means for registering a user in said website, means for obtaining a displayable object, means for personalizing said displayable object, means for generating a profile, means for entering personalized information in said profile, and means for searching user profiles in said database.

11. A method for linking the real world with the cyberworld comprising:
providing a displayable object to a first user wherein said displayable object comprises a user name identifier for said first user and a website identifier;
wearing or carrying said displayable object by said first user, so that is visible to a second user;
providing a website stored in a server and comprising a user name inquiry field, wherein said server is connected via a network to a client machine;
providing a user profile database comprising said first user's profile information and wherein said server is connected to said user profile database and comprises means for retrieving said first user's profile information from said database;
accessing said website by said second user through said client machine's web browser by entering said website identifier; and
retrieving said first user's profile information from said database by said second user via said website by entering said user name identifier in said user name inquiry field.

12. The method of claim 11 wherein said displayable object comprises one of tag, plate, ring, patch, pin, label, necklace, bracelet, key fob, belt clip, imprint on a piece of clothing, shoe, bag, personal communication device or electronic device, or tattoo.

13. The method of claim 11 wherein said displayable object further comprises one of residence address information of said first user, hologram, logo, symbol, magnetic stripe or bar code.

14. The method of claim 11 wherein said displayable object comprises one of metal, plastic, polycarbonate, flexible material, weather resistant material, or scratch resistant material.

15. The method of claim 11 further comprising sending messages to said first user by said second user via said website.

16. The method of claim 15 further comprising replying to said messages of said second user by said first user or evading said messages of said second user by said first user.

17. The system of claim 11 further comprising performing transactions by said first user via said website, wherein said transactions comprise one of making payments, placing orders, purchasing tickets or other digital goods or making reservations

18. The method of claim 11 wherein said first user's profile information comprise one of name, address, date of birth, phone number, e-mail address, homepage URL, personal preferences, hobbies, pictures, songs, favorite websites, slogans, videos, or blogs about opinions on politics, films or books.

19. The method of claim 11 wherein said website comprises one of a social networking website, a merchandising website, a news media website, or a personal website.

20. The method of claim 11 further comprising registering a user in said website, obtaining a displayable object, personalizing said displayable object, generating a profile, entering personalized information in said profile and searching user profiles in said database.
